(19) United States
(12) Patent Application Publication
(10) Pub. No.: US 2011/0121559 A1
(43) Pub. Date: May 26, 2011

(54) VERIFICATION PIN

(75) Inventor: Stephen Gunderson, Marine City, MI (US)

(73) Assignee: TI GROUP AUTOMOTIVE SYSTEMS, LLC, Auburn Hills, MI (US)

(21) Appl. No.: 12/950,145

(22) Filed: Nov. 19, 2010

Related U.S. Application Data
(60) Provisional application No. 61/263,691, filed on Nov. 23, 2009.

(51) Int. Cl. F16L 35/00; F16L 37/086

(52) U.S. Cl. 285/82; 285/91

(57) ABSTRACT

A quick connector coupling fitting includes a connector body having a through bore extending axially forward from an entrance opening at one end to an exit opening at an opposite end, the through bore defines a retainer receiving portion axially forward of the entrance opening, a tube receiving portion axially forward of the retainer receiving portion and a sealing chamber portion axially forward of the tube receiving portion. A tube retainer is disposed in the retainer receiving portion releasably secured to the connector body, and a seal element disposed in the seal chamber portion. A verification pin has a solid free end and a longitudinally elongate barrel portion with a cylindrical surface sized for fluid tight sealing relation with the sealing element. It includes opposed latching body portions extending from the barrel portion at an end opposite the solid free end releasably securing the verification pin to the retainer of the quick connector coupling fitting.

### CROSS-REFERENCE TO RELATED APPLICATION

This application claims priority, pursuant to Title 35 USC §119 to U.S. Provisional Patent Application No. 61/263,691, filed Nov. 23, 2009, entitled “Verification Pin,” the entire specification and drawings of which are hereby incorporated by reference herein as if fully set forth.

### BACKGROUND OF THE INVENTION

This disclosure relates to quick connector coupling fittings for fluid line systems. More particularly, it relates to an accessory to verify the integrity of the fitting elements prior to installation on a system component.

Quick connector couplings in the form of a fitting are commonly used to provide a fluid connection between a fluid conduit and a component of a fluid system. Such fittings are often employed in brake systems, power steering systems or refrigeration systems of automotive vehicles.

Typically the fitting includes a connector body that is secured by threads to a system component. The body defines a fluid passage and tube receiving bore to releasably receive a rigid tube to be connected to the system component. A retainer, carried by the connector body, releasably secures the tube to the body. A sealing element within the tube receiving bore provides a fluid tight seal between the connector body and the tube.

Quick connector coupling fittings are often manufactured by a manufacturer that supplies the fitting to another manufacturer that supplies the system components. The system components, with fittings attached, may then be supplied to an assembler of the system, for example, an automotive manufacturer for completion of a fluid system on a vehicle. The final assembly process entails insertion of the end form of a rigid tube into the tube receiving bore and releasable connection of the tube to the connector body in fluid tight relation. Prior to such installation, at one or more stages of production, it is desirable to confirm the integrity of the connector coupling fitting assembly to ensure completion of a secured fluid tight connection with the tube at final assembly. The verification pin of the present disclosure provides the mechanism to verify this integrity without the need to assemble a tube end form into the connector tube receiving passage.

### SUMMARY OF THE DISCLOSURE

The verification pin of the present disclosure comprises an elongate cylindrical pin releasably secured in the tube receiving bore of the connector body. It includes a sealing surface for fluid tight sealing relation to the sealing elements of the fitting. The pin is releasably secured to the retainer of the fitting assembly to withstand pressurization of the fluid passage and to confirm the integrity of the assembled fitting elements, namely the body, retainer and sealing elements.

The verification pin also acts as a barrier to entry of foreign matter into the tube receiving bore prior to completion of the coupling configuration. The pin includes deformable arms to disengage the verification pin from the fitting assembly to permit its removal at final assembly of the fluid coupling.

### BRIEF DESCRIPTION OF THE SEVERAL VIEWS OF THE DRAWINGS

FIG. 1 is a perspective view of a quick connector coupling fitting with a verification pin in place.

FIG. 2 is a sectional side view of a completed quick connector coupling employing the fitting of FIG. 1.

FIG. 3 is a side view of the retainer of the quick connector coupling of FIG. 2.

FIG. 4 is a further side view of the retainer of FIG. 3, rotated ninety degrees (90°) about its longitudinal axis relative to the view in FIG. 3.

FIG. 5 is a side sectional view of the retainer of FIG. 3.

FIG. 6 is a perspective view of the verification pin of the present disclosure.

FIG. 7 is a top view of the verification pin of the present disclosure.

FIG. 8 is a side view of the verification pin of the present disclosure.

FIG. 9 is a front view of the verification pin of the present disclosure.

FIG. 10 is a sectional side view of a quick connector coupling fitting with a verification pin of the present disclosure partially inserted into the tube receiving bore.

FIG. 11 is a sectional side view of a quick connector coupling fitting with a verification pin of the present disclosure installed and releasably secured to the retainer.

FIG. 12 is a fragmentary view, on an enlarged scale, of the quick connector coupling fitting and verification pin of FIG. 11.

### DETAILED DESCRIPTION OF THE ILLUSTRATED EMBODIMENT

FIG. 2 illustrates a quick connector fluid coupling 310 having a fitting or connector body 312, a tube retainer 314, a seal pack 316, an outer spacer 318, and a rigid tube 320. The tube 320 defines a male member having a radially directed upset 321 spaced from the free end 322 of the tube 320. The upset includes a rearward radial annular abutment surface 323. The male member includes an outer cylindrical sealing surface 324 between upset 321 and free end 322.

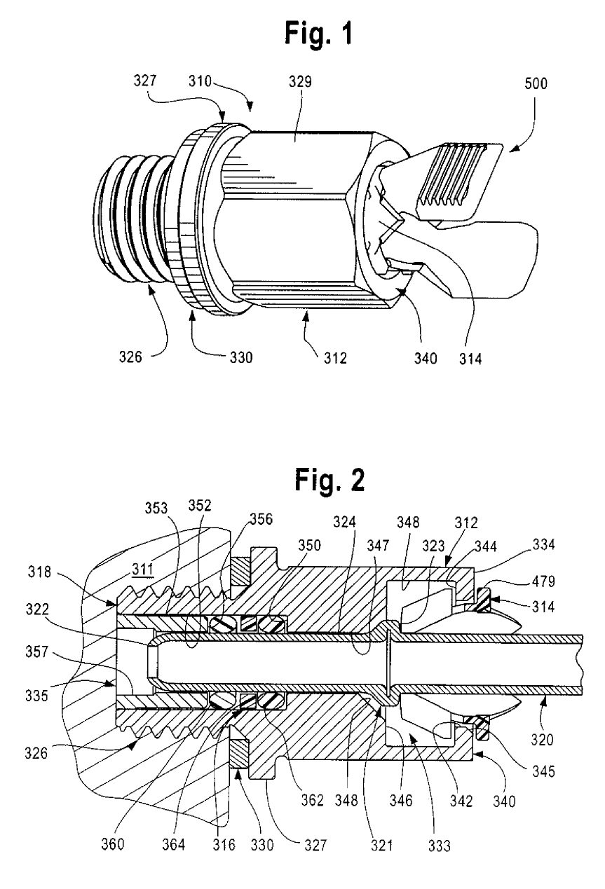

The fitting or body 312 includes a threaded end 326 connected to the system component 311 of a fluid system. The fitting or connector body 312 includes a radial flange 327 and a series of flats 329 to receive a wrench for tightening the fitting into a receptacle on the component complementary to the threaded end 326. (See also FIG. 1) A sealing washer 330 is interposed between the component 311 and the flange 327 of the fitting or connector body 312.

Connector body 312 defines a through bore 333 extending axially forward from an entrance opening at planar wall surface 334 to an exit opening 335 at threaded end 326. The bore 333 defines a retainer receiving portion axially forward of the entrance opening, a tube receiving portion axially forward of the retainer receiving portion, and a sealing chamber portion axially forward of the tube receiving portion that extends to exit opening 335. The bore 333 provides fluid communication to the fluid component 311 at exit opening 335.

In describing the quick connector coupling, the term longitudinal means axially along the longitudinal centerline of the fitting 312 and tube 320. The term axially forward, means a direction toward the threaded end 326. Axially rearward means in a direction toward the entrance opening from threaded end 326. The terms inward or inwardly means radially toward the longitudinal centerline of the fitting 312 and tube 320 and outward or outwardly means radially away from the longitudinal centerline.

The entrance opening at planar surface 334 is defined by an annular flange or rim 340 with a cylindrical surface 342 and a radially annular abutment or locking surface 344 forward of planar wall 334. Chamfer 345 connects cylindrical surface 342 with planar wall surface 334

The retainer receiving portion further includes cylindrical wall 348 of a diameter sufficient to house operative elements of the retainer 314. The retainer receiving portion includes a forward annular wall 346 spaced axially forward of radial annular abutment surface 344. Throughbore 333 includes cylindrical surface 347 having a diameter slightly larger than outer cylindrical sealing surface 324 of tube 320 that defines the tube receiving portion forward of forward annular wall 346. The chamfer 348 connects forward annular wall 346 and cylindrical surface 347. The cylindrical surface 347 surrounds the tube outer cylindrical sealing surface 324 and pilots or supports the tube 320 within the throughbore 333 of connector body 312.

Sealing chamber extends between a forwardmost radial annular wall 350 and exit opening 335. It includes a cylindrical sealing surface 352 of a diameter larger than the diameter of cylindrical surface 347 of the tube receiving portion. It is sized to contain seal pack 316 in surrounding relation to the outer cylindrical sealing surface 324 of tube 320.

Outer spacer 318 is an annular sleeve having an outer cylindrical engagement surface 353 secured by interference or press fit within cylindrical sealing surface 352. It includes a rearward facing radial annular seal retention surface 356 spaced from forwardmost radial annular wall 350. Outer spacer includes an internal bore defined by surface 357 having a diameter slightly larger than outer cylindrical sealing surface 324 of tube 320. It defines a passage in fluid communication with the free end 322 of tube 320. It provides fluid communication to the component 311 associated with the quick connector coupling 310 at exit opening 335.

Seal pack 316 is disposed between the forwardmost radial annular wall 350 and rearward facing radial annular seal retention surface 356 of outer spacer 318. It includes a pair of resilient polymeric O-rings 360 and 362 and an annular seal spacer 364. The spacer 364 separates the resilient O-rings 360 and 362. The resilient O-rings 360 and 362 are sized to be deformed into fluid tight sealing contact with outer cylindrical sealing surface 324 of tube 320 and cylindrical sealing surface 352 of seal chamber portion.

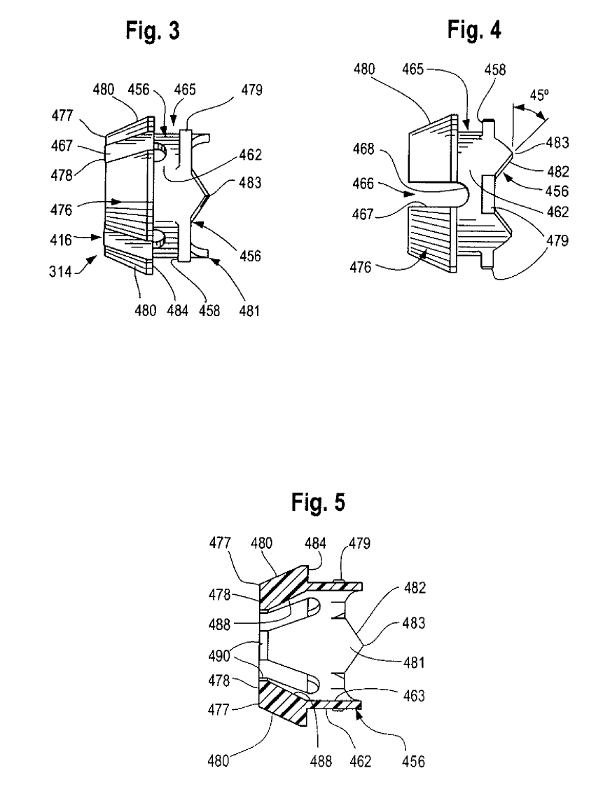

The tube retainer 314, best seen in FIGS. 3 to 5, is disclosed in U.S. Patent Application Publication No. 2008/0231044 of application Ser. No. 12/048,947, filed Mar. 14, 2008, the specification and drawings of which are incorporated by reference herein. Retainer 314 is an annular member. It includes a cylindrical ring 456 having an outer cylindrical surface 462 and an inner cylindrical surface 463.

The diameter of outer cylindrical surface 462 is somewhat smaller than the diameter of cylindrical surface 342 of rim 340 such that the ring 456 of retainer 314 is loosely piloted therein. The diameter of inner cylindrical surface 463 of ring 456 is larger than the diameter of upset 321 of tube 320 to permit passage of the tube 320 and upset 321 through the ring 456 during insertion of tube 320 into body 312.

The retainer 314 also includes four axially extending duck bills or locking arms 476 with slots 466 between them. The slots 466 are defined by axially extending side faces 467 that terminate at curved end surfaces 468, best seen in FIG. 4.

The locking arms 476 of retainer 314 have forward arcuate, generally radial abutment surfaces 478 that abut the tube upset 321 and rearward arcuate abutment surfaces 484 that abut radial annular abutment or locking surface 344 of rim 340 when the retainer 314 is installed into the connector body 312.

The locking arms 476 define top ramped surface 480, interior ramped surface 488 and cylindrical bottom surface 490. The locking arms are angled to diverge rearwardly toward rear abutment surfaces 484. On insertion of the male member or tube 320 into the entrance opening at planar face 334, the upset 321 contacts the interior ramped surfaces 488 and deflects the locking arms 476 radially outward to permit passage of the upset 321 forward beyond the front abutment surfaces 478. When the tube is fully inserted, the upset 321 resides forward of the locking arms 478 and the arms return to their normal position with cylindrical bottom surfaces 490 overlying the outer cylindrical sealing surface 324 of tube 320 rearward of the upset 321. The forward abutment surfaces 478 abut the radial annular abutment surface 323 of upset 321. Forward axial movement of tube 320 is limited by contact of upset 321 with chamfer 348 of bore 333.

The rearward end of ring 456 is provided with four radial protrusions 479 defining forward faces 458. These surfaces define a channel 465 with the rear abutment surfaces 484. The axial forward movement of retainer 314 is limited by the forward faces 458. Channel 465 is sized to receive the rim 340 of the connector body 312. The cylindrical surface 342 of the connector body 312 overlies the outer cylindrical surface 462.

Intermediate each protrusion 479 is a rearwardly directed guide element 481 defined by two angled guide surfaces 482 formed at an angle of forty-five degrees)(45° to a plane perpendicular to the longitudinal axis of the retainer 314. The surfaces are thus ninety degrees) (90° to each other and meet at a central apex 483. The guide surfaces 482 are chamfered to diverge in the forward direction.

When the retainer 314 is assembled to the connector body 312, the rim 340 resides radially outward of cylindrical surface 462 of ring 456. The rear abutment surfaces 484 of locking arms 476 abut the radial annular abutment surface 344 of rim 340. This relationship delivers the axial load of tube 320 to the radial annular abutment surface 344 of the connector body 312 from upset 321 through locking arms 476.

As seen in FIG. 1, quick connector coupling fittings 310 are preassembled to include the connector body 312, tube retainer 314, seal pack 316 and outer spacer 318. These sub-assemblies are protected by a verification pin 500. In this form, they are delivered to a supplier of system components such as the component 311 of FIG. 2. In turn, the fittings 310 are installed into a system component 311 which is then delivered to an assembler, such as an automotive manufacturer, for ultimate installation into a fluid line system on a vehicle. This latter step includes insertion of the tube 320 into the coupling body 312 to complete the fluid tight coupling. At this juncture, the verification pin 500 is removed and discarded prior to insertion of the tube 320 to complete the fluid coupling.

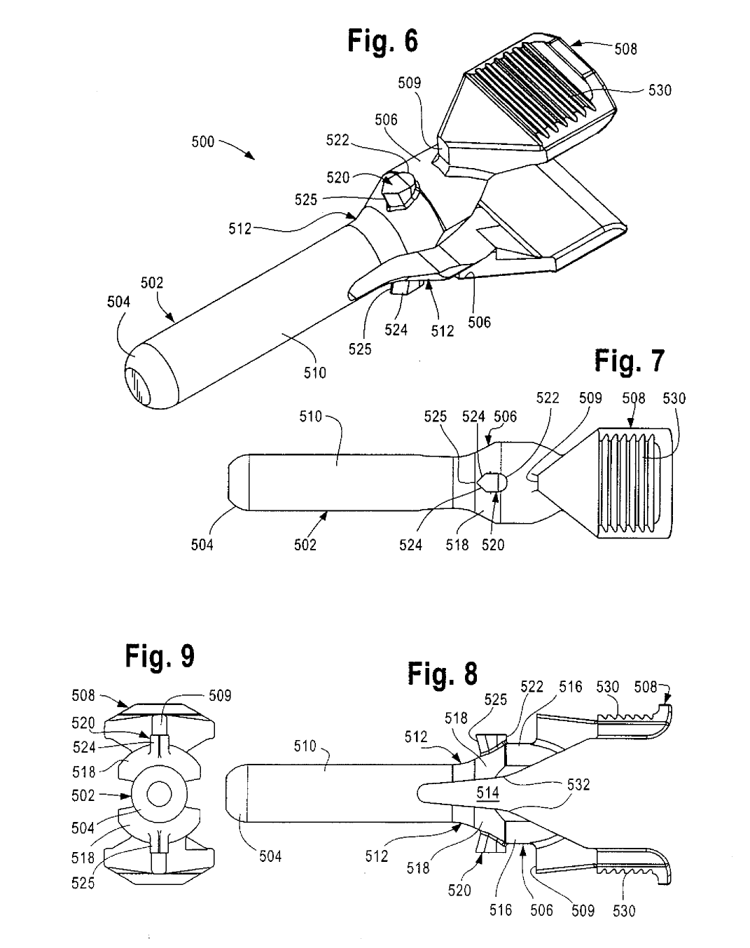

At one or more stages of the process, it is desirable to test the integrity of the fitting 310 to ensure that it includes all components and will perform its function of fluid tight releasable retention of the tube 314. It is also important to protect the tube receiving bore 333 from debris or other detrimental ingress prior to completion of the coupling connection. The verification pin 500 of the present disclosure provides these capabilities. It is illustrated in FIGS. 6 to 12. Verification pin 500 is employed in the sequence of manufacture, testing and installation of quick connector coupling fittings such as fitting 310 of FIG. 1. Installed into bore 333 after assembly of the fitting 310, the verification pin 500 permits pressure testing (leak testing) of fittings 310 prior to assembly of the fitting onto a system component 311. It also prevents ingress of debris or other foreign matter prior to installation of tube 320.

Verification pin 500 is a unitary structure made of polymeric material such as polypthalamide (PPA). It includes a longitudinally elongate barrel portion 502 having a solid rounded free end 504 which aids in its insertion into the bore 333 of body 312. A latching portion is defined by a pair of latching body portions 506. These latching bodies 506 releasably secure the pin 500 to the fitting 310. Actuation finger portions 508 provide mechanism for releasing the latching body portions 506 for removal of the pin 500 from fitting 312.

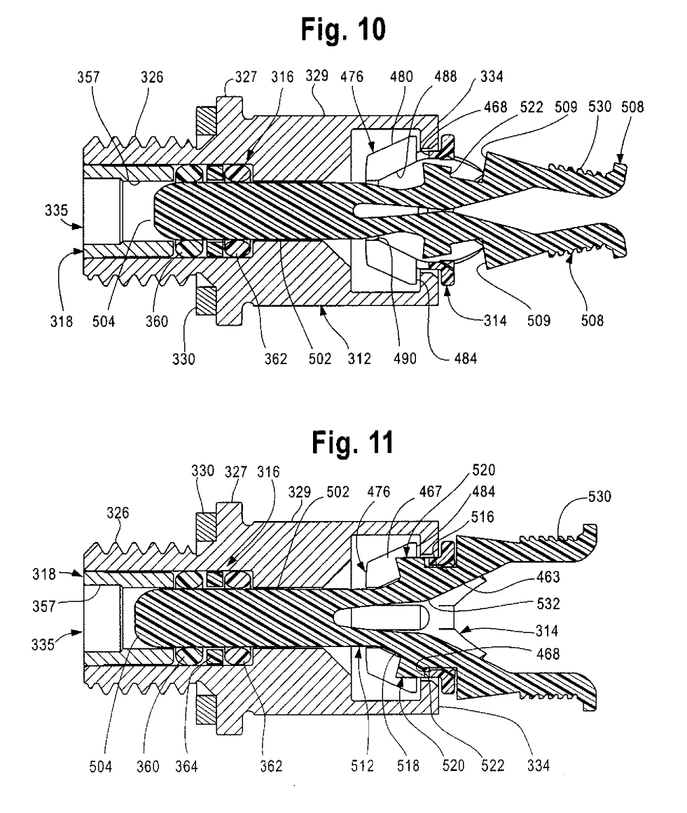

Barrel portion 502 includes an outer cylindrical sealing surface 510 that is sized to about the same diameter as the outer cylindrical sealing surface 324 of rigid tube 320. With verification pin 500 inserted into throughbore 333 through entrance opening at planar wall surface 334, as illustrated in FIG. 10, the barrel portion 502 has an axial length to extend into outer spacer 318. Barrel portion 502 is piloted in cylindrical surface 347 of tube receiving portion of connector body 312. The barrel portion 502 extends through the seal chamber portion through the elements of seal pack 316. The O-ring seals 360 and 362 are compressed between outer cylindrical sealing surface 510 of barrel portion 502 and cylindrical sealing surface 352 to provide a fluid tight seal. The rounded free end 504 of barrel portion 502 is piloted in the internal bore surface 357 of outer spacer 318.

Each latching body portion 506 is integrally connected to barrel portion 502 by an axial extending beam portion 512 extending from the barrel portion 502 at an end opposite the free end 504. The beam portions 512 define a generally “V” shaped space 514 which, on application of radial inward force to actuation finger portions 508 permit radial deflection of the latching body portions 506 toward each other.

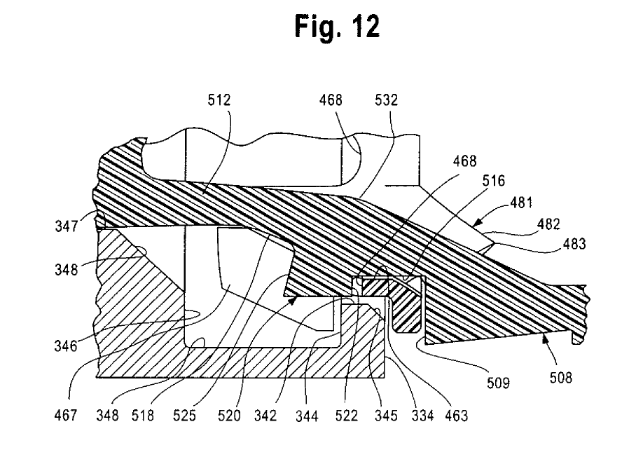

The latching body portions 506 each have an arcuate cylindrical surface 516 formed on a diameter slightly smaller than the diameter of inner cylindrical surface 463 of ring 456 of retainer 314. As best seen in FIGS. 11 and 12, the beam portions 512 and latching body portions 506 are configured such that, in the unstressed condition of beam portions 512, the arcuate cylindrical surfaces 516 are positioned to reside within inner cylindrical surface 463 of ring 456 of tube retainer 314.

The latching body portions 506 each include an arcuate conical surface 518 diverging from barrel portion 502 to arcuate cylindrical surface 516. The arcuate conical surfaces 518 normally reside within the interior ramped surfaces 488 defined by locking arms 476.

Each latching body portion 506 is provided with a radially outwardly directed pawl 520 integrally formed at the arcuate conical surfaces 518. The pawls 520 are disposed one hundred eighty degrees)(180° apart and are sized and positioned to fit between adjacent locking arms 476 within a slot 466.

Each pawl 520 includes a rearward radial abutment surface 522 that is curved to be complementary to the curved end surfaces 468 of slots 466 between adjacent locking arms 476 of tube retainer 314. At full insertion of the verification pin 500 into throughbore 333 of a sub-assembly of fitting body 312 and tube retainer 314 with beams 512 unstressed, the pawls 520 latch against axial rearward movement by abutment of radial abutment surfaces 522 against curved end surfaces 468 of slots 466 between adjacent locking arms 476. When so latched, the outer cylindrical sealing surface 510 of barrel portion 502 is disposed in fluid tight sealing relation with the O-ring seals 360 and 362.

Each of the pawls 520 includes forward guide surfaces 524 that forwardly converge to meet at an apex 525 and extend rearwardly from the apex 525 at an angle of forty five degrees) (45° to the longitudinal extent of pin 500, i.e. ninety degrees)(90° to each other. On axial insertion of the verification pin 500, contact of the guide surfaces 524 with angled surfaces 482 of guide elements 481 results in rotation of the verification pin 506 to position pawls 520 in alignment with two slots 466 and permit the pawls to pass into the two slots 466 between the side surfaces 467 of adjacent locking arms 476.

Release finger portions 508 extend from latching body portions 506. The forward end of each release finger 508 defines a stop surface 509 generally perpendicular to the longitudinal axis of the verification pin 500. It is spaced from rearward abutment surfaces 522 of pawls 520 a distance so as to reside rearward of a protrusion 479 of tube retainer 314 when rearward abutment surfaces 522 are in abutting contact with curved end surfaces 468 of two slots 466. This relationship limits permissible forward insertion of verification pin 500 into throughbore 333. This contact determines the limit of forward movement of verification pin 500 relative to tube retainer 314.

Each release finger portion 508 includes a planar ribbed surface 530 for radial inward manual manipulation of the finger portions, and latching body portions 506 toward each other to reduce the size of space 514. A stop surface 532 limits the permissible movement of the locking body portions 506 toward each other. When so compressed, as illustrated in FIG. 10, the pawls are spaced apart such that they are free to pass through the inner cylindrical surface 463 of cylindrical ring 456 of tube retainer 314. Verification pin 500 may be axially withdrawn from throughbore 333 of fitting 312.

The quick connector coupling sub-assembly including connector body or fitting 312, tube retainer 314, seal pack 316 and outer spacer 318 is manufactured and assembled for later attachment to a fluid component such as illustrated in FIG. 2. The verification pin 500 is axially releasably secured into throughbore 333 as shown in FIGS. 11 and 12 to create the sub-assembly illustrated in FIG. 1. During insertion of verification pin 500 the beam portions 512 are depressed radially inward until the pawls 520 pass through inner cylindrical surface 463 of ring 456 of tube retainer 314. The forward guide surfaces 524 of the two pawls 520 contact angled surfaces 482 of two of the guide elements 481 to circumferentially align the pawls 520 with two of the slots 466 between locking arms 476. After the pawls 520 move sufficiently forward to pass beyond cylindrical ring 456, the pawls enter slots 466 between side faces 467 to place the rearward abutment surface 522 of each pawl 520 in abutting relation to a curved end surface 468 of a slot 466. On release, the beam portions 512 flex radially outward to an unstressed condition with the pawls 520 captured within two slots 466 disposed one hundred eighty degrees)(180° apart.

The arcuate cylindrical surface 516 of each latching body 506 lies within inner cylindrical surface 463 of ring 456 and arcuate conical surfaces 518 are surrounded by interior ramped surfaces 488 of locking arms 476. Stop surfaces 509 of actuation finger portions 508 abut protrusions 479. The outer cylindrical sealing surface 510 of barrel portion 502 of verification pin 500 is disposed in fluid tight relation to O-rings 360 and 362 of seal pack 316.

The quick connector coupling fitting 310 with verification pin 500 releasably attached may be installed onto a test fixture to test against leakage of the seal pack 316 within seal chamber portion. The threaded end 326 is screwed into a test fixture and its connection sealed by sealing washer 330. On pressurization, fluid under pressure enters the passage defined by surface 357 on outer spacer 318 through exit opening 335. The O-ring seals 360 and 362 are compressed in fluid tight relation between cylindrical sealing surface 352 of seal chamber portion of connector body 312 and outer cylindrical sealing surface 510 of barrel portion 502 of verification pin 500. Any leakage from fitting body 312 will indicate the absence of, or change to, to the components of seal pack 316.

Pressurization of passage 358 imparts axial forces to solid rounded free end 504 of verification pin 500 to urge it axially rearward out of the thoughbore 333. The latching relation of the rearward abutment surfaces 522 of pawls 520 with curved end surfaces 468 of slots 466 prevents such movement and retains the verification pin 500 in position within connector body 312. Since the releasable latching connection of the verification pin 500 to the sub-assembly is with the tube retainer 314 rather than a surface on connector body 312, for example, radial annular abutment surface 344, successful pressure testing verifies the presence of the tube retainer 314 on the assemblage.

At the stage of assembly of a tube 320 into the connector body 312, the verification pin 500 is easily removed, and discarded. Actuation fingers 508 are manipulated toward each other until the pawls 520 can pass through inner cylindrical surface 463 of cylindrical ring 456 of retainer. The tube 320 is inserted into the throughbore 333 of connector body 312 to complete a fluid tight coupling 310.

Various features of the present invention have been described with reference to the illustrated embodiments. It should be understood that modifications may be made without departing from the spirit and scope of the present invention as recited by the following claims.

1. A quick connector coupling fitting comprising:
a connector body having a through bore extending axially forward from an entrance opening at one end to an exit opening at an opposite end, said through bore defining a retainer receiving portion axially forward of said entrance opening, a tube receiving portion axially forward of said retainer receiving portion and a sealing chamber portion axially forward of said tube receiving portion
a tube retainer disposed in said retainer receiving portion releasably secured to said connector body;
a seal element disposed in said seal chamber portion,
a verification pin having a solid free end disposed in said through bore, said pin including an elongate barrel portion in fluid tight sealing relation with said seal element in said seal chamber portion;
opposed latching body portions each including an axial extending beam portion extending from said elongate barrel portion at an end opposite said solid free end, said latching body portion releasably engaged with said retainer to releasably secure said verification pin within said throughbore.

2. A quick connector coupling fitting as claimed in claim 1 wherein said retainer includes a plurality of axially extending locking arms with slots between them defined by axially extending side faces that terminate in curved end surfaces and wherein at least one of said latching body portions includes a radially outwardly directed pawl disposed within one of said slots, said at least one pawl including a rearward radial abutment surface in abutting relation to said curved end surface of said slot.

3. A quick connector coupling fitting assembly as claimed in claim 2 wherein each said latching body portion includes a radially outwardly directed pawl disposed within one of said slots, said pawls each including a curved rearward radial abutment surface abutting one of said curved end surfaces of one of said slots.

4. A quick connector coupling fitting as claimed in claim 3 wherein said retainer includes a plurality of rearwardly directed guide elements each defined by two angled guide surfaces formed at an angle relative to a plane perpendicular to the longitudinal axis of said retainer, and wherein each said pawl includes forward guide surfaces that forwardly converge to an apex, said forward guide surfaces extending rearwardly from said apex at an angle to the longitudinal extent of said pin, said angled guide surfaces of said rearwardly directed guide elements of said retainer and said forward guide surfaces of said pawls coacting to align said pawls of said verification pin with said slots between said locking members of said retainer on insertion of said pin into said throughbore of said connector body.

5. A quick connector coupling fitting as claimed in claim 4 wherein said angled guide surfaces of each said rearwardly directed guide elements of said retainer are formed at an angle of ninety degrees)(90° to each other and forty-five degrees)(45° to the plane perpendicular to the longitudinal axis of said retainer and said forward guide surfaces of each said pawl extend rearwardly from said apex at an angle of forty-five degrees)(45° to the longitudinal extent of said pin and ninety degrees)(90° to each other.

6. A quick connector coupling fitting as claimed in claim 4 wherein each said release finger includes a forward end defining a stop surface generally perpendicular to the longitudinal axis of said verification pin spaced axially from said curved radial abutment surface of one of said pawls.

7. A quick connector coupling fitting assembly as claimed in claim 6 wherein said connector body includes an annular rim defining a radially annular locking surface forward of said entrance opening, said retainer includes a ring portion disposed within said rim; said axially extending locking arms each include a rearward abutment surface abutting said radially annular locking surface of said connector body, said rearwardly directed guide elements extend rearwardly from said ring and said ring includes a plurality of radial protrusions disposed between said guide elements that define a channel with said rearward abutment surfaces of said locking arms, and wherein said stop surfaces of said release fingers are disposed rearwardly of said protrusions when said rearward abutment surfaces of said pawls are in abutting relation to said curved end surfaces of said slots.

8. A quick connector coupling fitting as claimed in claim 1 wherein said elongate barrel portion includes an outer cylindrical surface and said solid free end is disposed in said sealing chamber portion of said through bore, and said seal element includes at least one O-ring seal disposed in fluid tight relation between said cylindrical surface and said seal chamber portion of said connector body.

9. A quick connector coupling fitting as claimed in claim 8 wherein an annular outer spacer is disposed in said seal chamber defining portion of said through bore forward of said seal element and said solid free end of said elongate cylindrical barrel portion is disposed in said outer spacer.

10. A quick connector coupling fitting as claimed in claim 1 wherein said opposed axial extending beam portions define a generally “V” shaped space between them which permits radial deflection of said latching body portions toward each other on application of radial inward force.

11. A quick connector coupling fitting as claimed in claim 10 wherein a release finger extends from each said latching body portion at an end opposite said axial extending beam portion.

12. A verification pin for a quick connector coupling fitting having a connector body defining a fluid passage and tube receiving bore to releasably receive a rigid tube, a retainer carried by the connector body to releasably secure the tube to the body, and sealing element within the tube receiving bore to provide a fluid tight seal between the bore in the body and the tube, said verification pin adapted to be releasably secured within the tube receiving bore of the connector body, said pin comprising:
a longitudinally elongate barrel portion having a solid free end and a cylindrical surface sized for fluid tight sealing relation with the sealing element of the fitting;
at least one latching body portion extending from said barrel portion at an end opposite said solid free end, said at least one latching body portion adapted to releasably secure said verification pin to the quick connector coupling fitting.

13. A verification pin as claimed in claim 12 wherein said pin includes opposed latching body portions, each said latching body portion including an axial extending beam portion extending from said elongate barrel portion at said end opposite said solid free end, said latching body portions defining a generally “V” shaped space between them to permit radial deflection of said latching body portion toward the other.

14. A verification pin as claimed in claim 13 wherein each said latching body portion includes a radially directed pawl, each said pawl including a curved rearward radial abutment surface.

15. A verification pin as claimed in claim 14 wherein each said pawl includes forward guide surfaces that forwardly converge to meet at an apex.

16. A verification pin as claimed in claim 15 wherein a release finger extends from each said latching body portion at an end opposite said axial extending beam portion.

17. A verification pin as claimed in claim 16 wherein said release fingers include a forward end defining a stop surface generally perpendicular to the longitudinal axis of said verification pin spaced axially from said curved radial abutment surface of said pawl.

18. A verification pin as claimed in claim 15 wherein said forward guide surfaces of each said pawl extend rearwardly from said apex at an angle of forty-five degrees)(45° to the longitudinal extent of said pin and ninety degrees)(90° to each other.
